(19) United States
(12) Patent Application Publication
(10) Pub. No.: US 2023/0014463 A1
(43) Pub. Date: Jan. 19, 2023

(54) PRINTING SYSTEM INCLUDING PRINTER CONFIGURED TO PRINT IMAGE WHEN DETERMINING THAT AUTHORITY INFORMATION INDICATING AUTHORITY TO PRINT IMAGE IS VALID

(71) Applicant: Brother Kogyo Kabushiki Kaisha, Nagoya (JP)

(72) Inventors: Tetsuya OKUNO, Nagoya (JP); Shunsuke MINAMIKAWA, Nagoya (JP); Haruka AZECHI, Nagoya (JP); Ayaka HOTTA, Kitanagoya (JP); Yushi DEURA, Nagoya (JP)

(73) Assignee: Brother Kogyo Kabushiki Kaisha, Nagoya (JP)

(21) Appl. No.: 17/935,983

(22) Filed: Sep. 28, 2022

Related U.S. Application Data
(63) Continuation of application No. PCT/JP2021/011392, filed on Mar. 19, 2021.

(30) Foreign Application Priority Data
Mar. 31, 2020 (JP) 2020-065161

(51) Int. Cl. G06F 3/12

(52) U.S. Cl. CPC G06F 3/1222; G06F 3/1288; G06F 3/1239; G06F 3/1236

(57) ABSTRACT

A printing system includes: a printer including a controller; and a contract processing server. The controller is configured to perform: determining, in response to receiving from an external device a print job including print data representing an image, whether authority information indicating an authority to print the image has been issued; and transmitting, in response to determining that the authority information has been issued, to the contract processing server an inquiry for determining whether the authority information is valid. The contract processing server is configured to perform: transmitting, in response to receiving the inquiry, a response to the controller. The controller is configured to further perform: determining, in response to receiving the response, whether the authority information is valid on the basis of the received response; and printing, in response to determining that the authority information is valid, the image on a print medium by controlling the printer.

### REFERENCE TO RELATED APPLICATIONS

This is a by-pass continuation application of International Application No. PCT/JP2021/011392 filed Mar. 19, 2021 claiming priority from Japanese Patent Application No. 2020-065161 filed Mar. 31, 2020. The entire contents of the International Application and the priority application are incorporated herein by reference.

### BACKGROUND ART

A prior art describes a document printing system for perform printing based on print data. In this conventional system, print data is transmitted to an MFP from an electronic device of a user, and is stored in the MFP. Thereafter, the MFP transmits the print data to a computer so that the computer calculates an amount of fee required for performing printing. After the calculated fee has been paid, the MFP performs printing based on the print data.

### DESCRIPTION

The document printing system in the prior art focuses only on the valid printing of print data by legitimate users that have paid a fee in accordance with a contract, for example, but gives no particular consideration to any potential for unauthorized printing by someone who has falsified payment, for example.

In view of the foregoing, it is an object of the present disclosure to provide a printing system, a printer, a storage medium storing set of computer-readable instructions, and a printing method capable of restraining unauthorized printing on the printer.

In order to attain the above and other object, the present disclosure provides a printing system including: a printer including a controller; and a contract processing server. The controller is configured to perform: (1a) determining, in response to receiving from an external device a print job including print data representing an image, whether authority information indicating an authority to print the image has been issued; and (1b) transmitting, in response to the (1a) determining that the authority information has been issued, to the contract processing server an inquiry for determining whether the authority information is valid. The contract processing server is configured to perform: (2a) transmitting, in response to receiving the inquiry transmitted in the (1b) transmitting, a response to the controller. The controller is configured to further perform: (1c) determining, in response to receiving the response transmitted in the (2a) transmitting, whether the authority information is valid on the basis of the received response; and (1d) printing, in response to the (1c) determining that the authority information is valid, the image on a print medium by controlling the printer.

In the above operation, the controller of the printer determines whether the authority information is present for printing the image represented by the print data in the print job received from the external device. When determining that the authority information is present, the controller transmits the inquiry to the contract processing server to determine whether the authority information is valid. Then, when determining that the authority information is valid, the printer prints the image for the print job. In other words, when determining that the authority information is not present for the printer, the printer does not print the image in the print job.

This operation can restrain unauthorized printing on the printer. Unauthorized printing includes cases in which the print job is transmitted by a person other than the user who previously concluded a contract to execute the print job on the printer, or cases in which the printer differs from a printer for which the contract to execute the print job has been concluded. Accordingly, user confidence for using a printing service can be improved, and the service provider can be restrained from incurring loss due to unauthorized use and the like.

According to another aspect, the present disclosure also provides a printer including a controller configured to perform: (a) determining, in response to receiving from an external device a print job including print data representing an image, whether authority information indicating an authority to print the image has been issued; (b) transmitting, in response to the (a) determining that the authority information has been issued, to a contract processing server an inquiry for determining whether the authority information is valid; (c) determining, in response to receiving a response to the inquiry from the contract processing server, whether the authority information is valid on the basis of the received response; and (d) printing, in response to the (c) determining that the authority information is valid, the image on a print medium by controlling the printer.

According to still another aspect, the present disclosure also provides a non-transitory computer-readable storage medium storing a set of program instructions for a printer including a controller. The set of program instructions, when executed by the controller, causes the printer to perform: (a) determining, in response to receiving from an external device a print job including print data representing an image, whether authority information indicating an authority to print the image has been issued; (b) transmitting, in response to the (a) determining that the authority information has been issued, to a contract processing server an inquiry for determining whether the authority information is valid; (c) determining, in response to receiving a response to the inquiry from the contract processing server, whether the authority information is valid on the basis of the received response; and (d) printing, in response to the (c) determining that the authority information is valid, the image on a print medium.

According to still another aspect, the present disclosure also provides a method for a printing system. The method includes: (a) determining, in response to receiving from an external device a print job including print data representing an image, whether authority information indicating an authority to print the image has been issued; (b) making, in response to the (a) determining that the authority information has been issued, an inquiry for determining whether the authority information is valid; (c) making a response to the inquiry; (d) determining, in response to acquiring the response to the inquiry, whether the authority information is valid on the basis of the acquired response; and (e) printing, in response to the (d) determining that the authority information is valid, the image on a print medium.

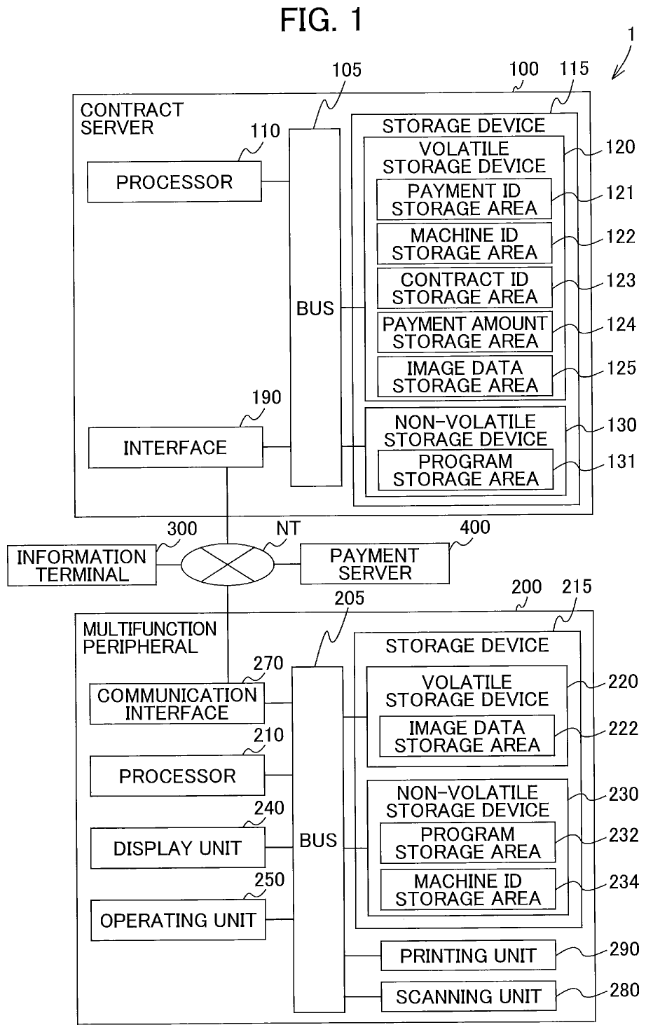

FIG. 1 is a block diagram illustrating an overall outlined configuration of a printing system.

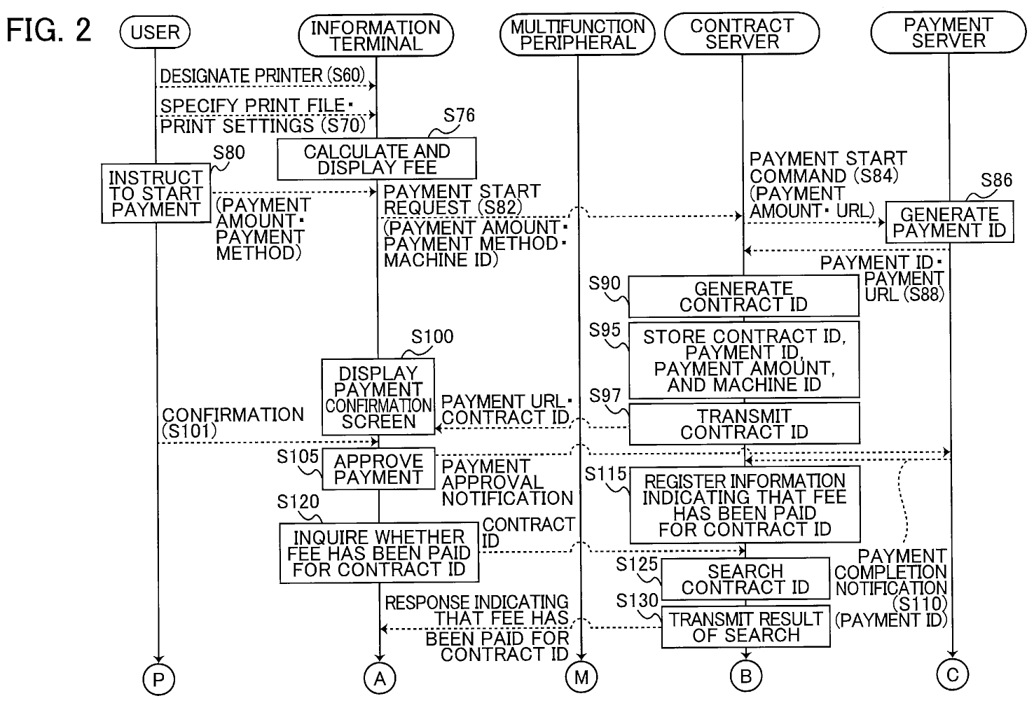

FIG. 2 is a sequence diagram illustrating a first part of a process executed by an information terminal, a multifunction peripheral, a contract server, and a payment server.

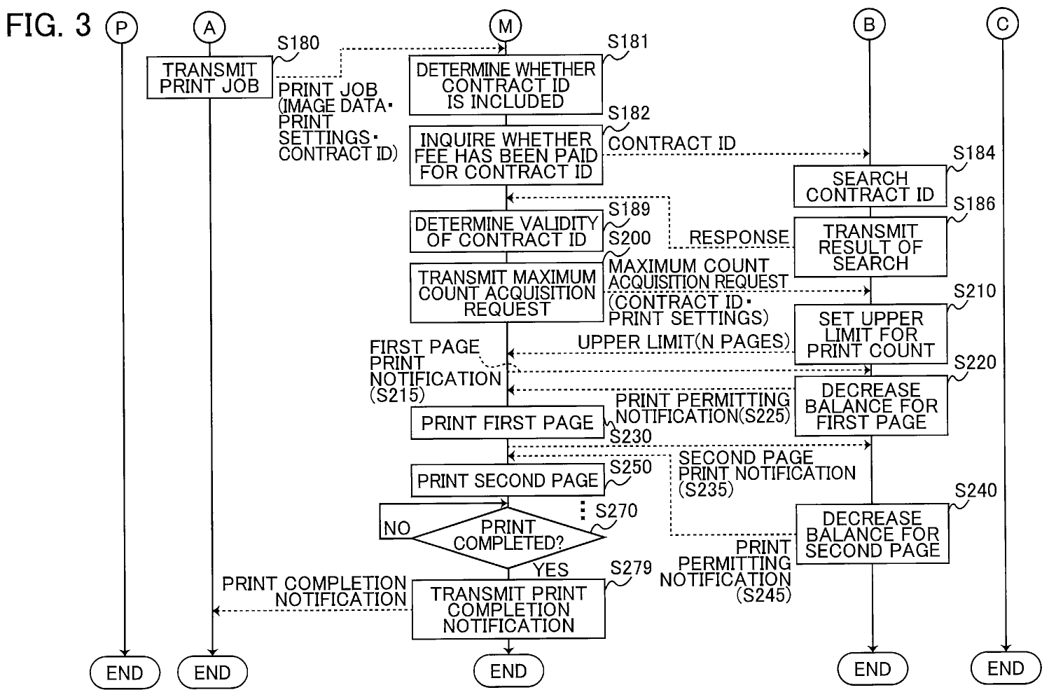

FIG. 3 is a sequence diagram illustrating a second part of the process executed by the information terminal, the multifunction peripheral, the contract server, and the payment server.

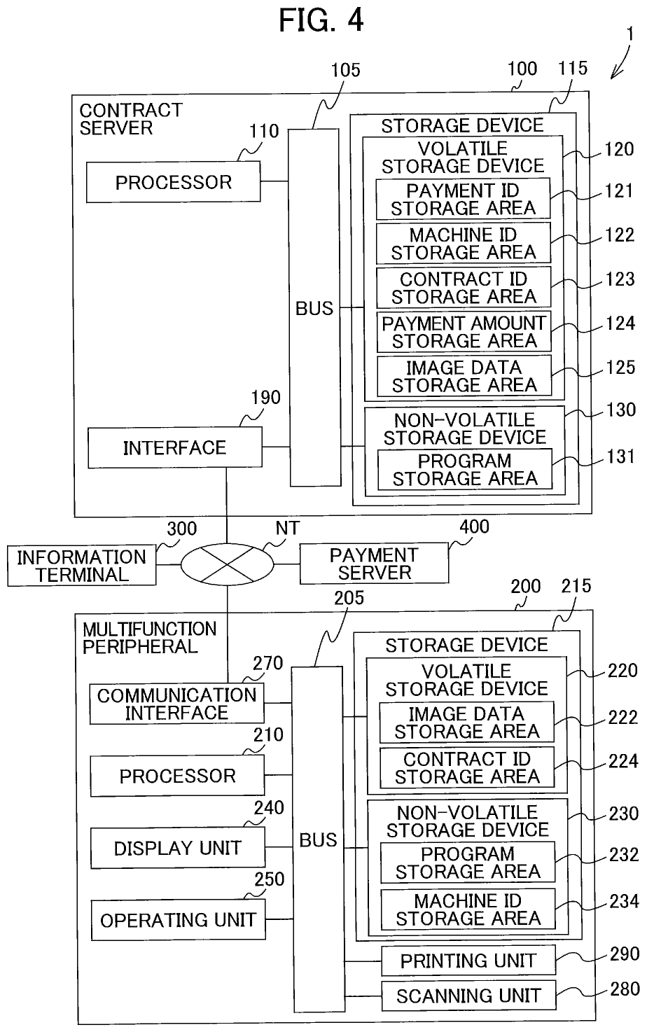

FIG. 4 is a block diagram illustrating an overall outlined configuration of a printing system.

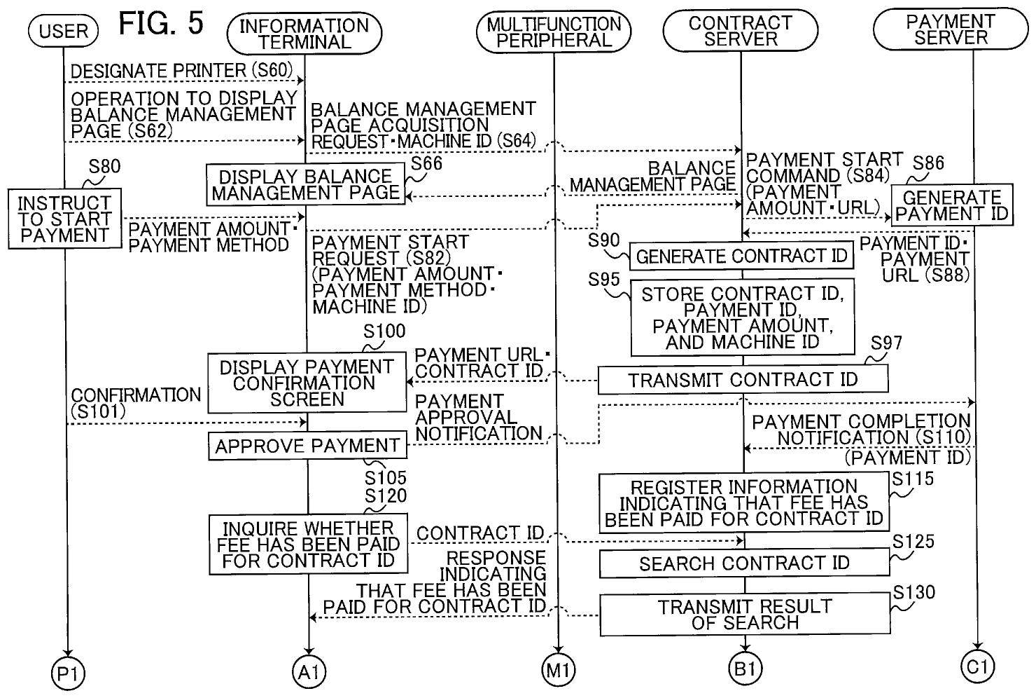

FIG. 5 is a sequence diagram illustrating a first part of a process executed by the information terminal, a multifunction peripheral, the contract server, and the payment server.

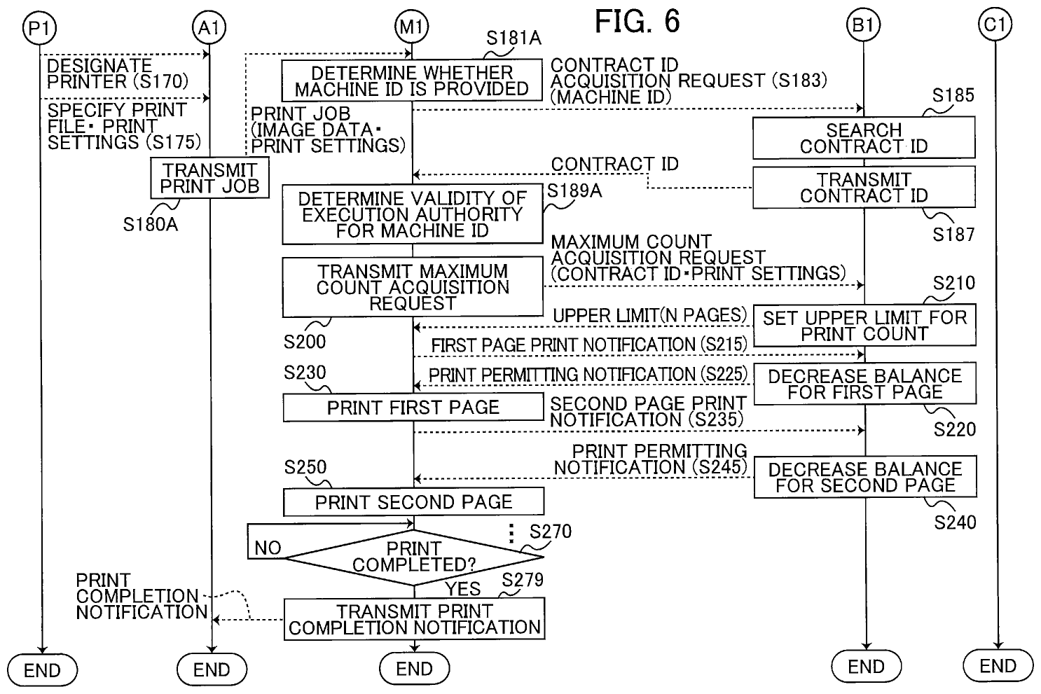

FIG. 6 is a sequence diagram illustrating a second part of the process executed by the information terminal, the multifunction peripheral, the contract server, and the payment server.

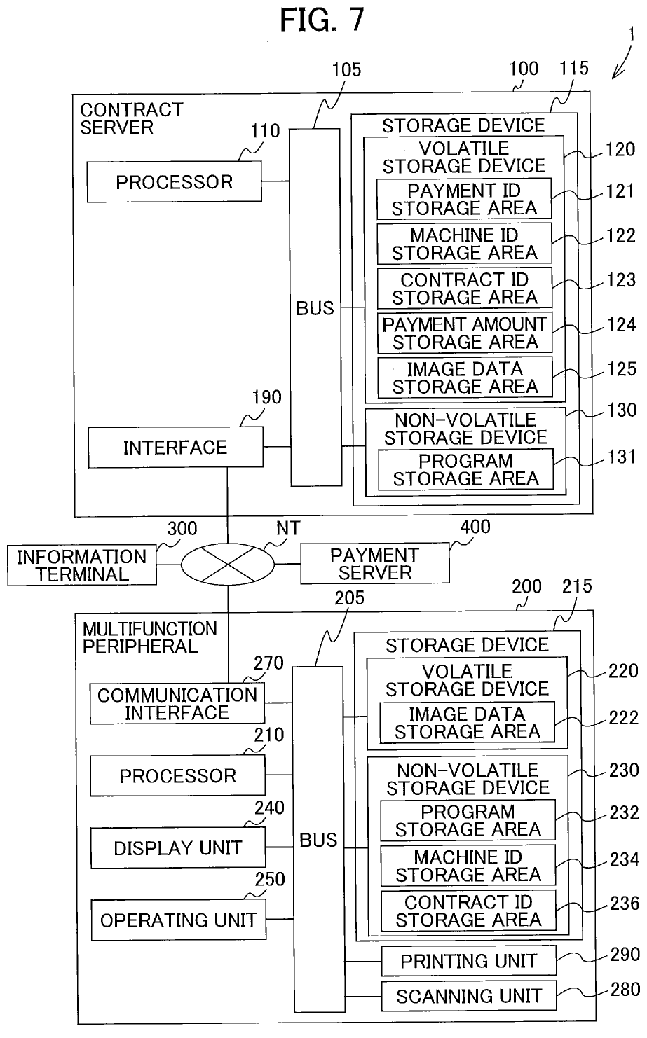

FIG. 7 is a block diagram illustrating an overall outlined configuration of a printing system.

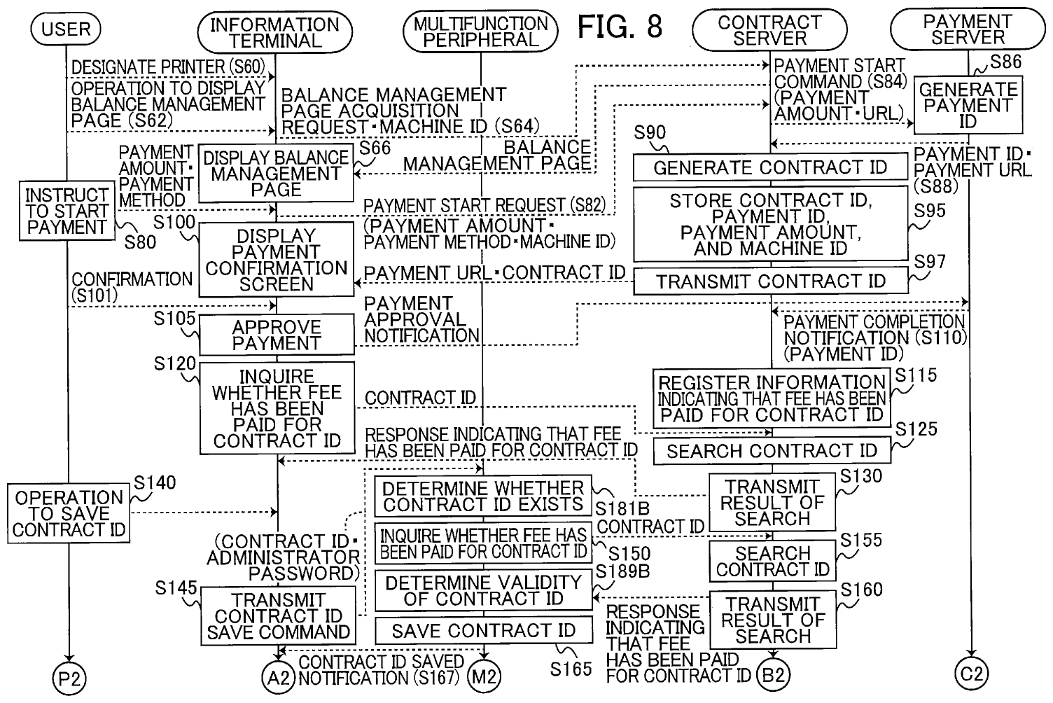

FIG. 8 is a sequence diagram illustrating a first part of a process executed by the information terminal, a multifunction peripheral, the contract server, and the payment server.

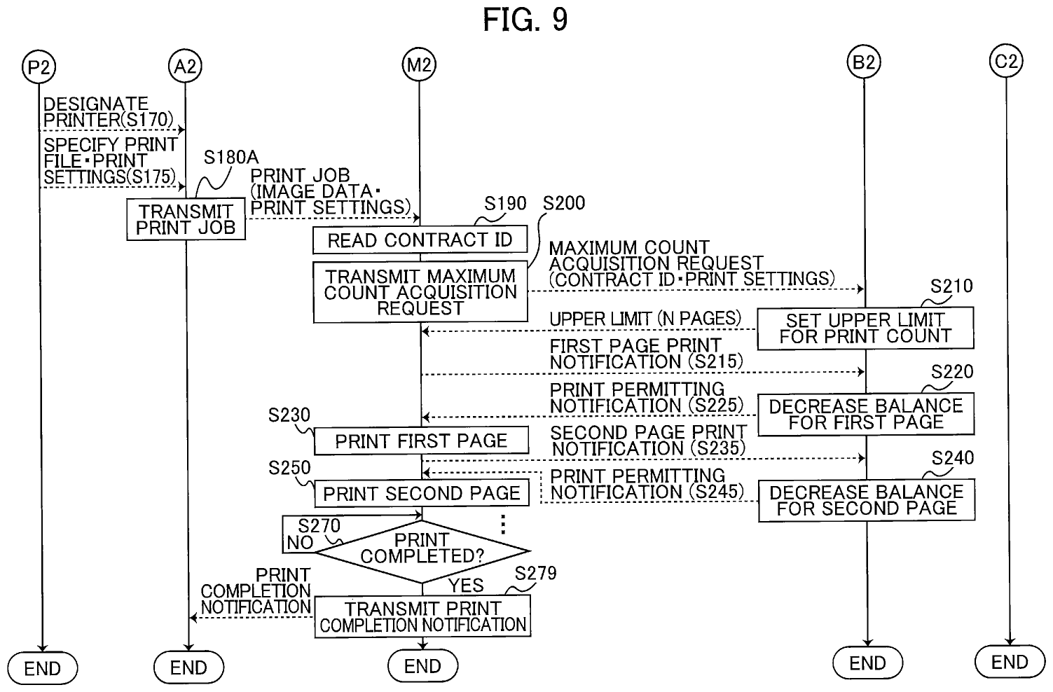

FIG. 9 is a sequence diagram illustrating a second part of the process executed by the information terminal, the multifunction peripheral, the contract server, and the payment server.

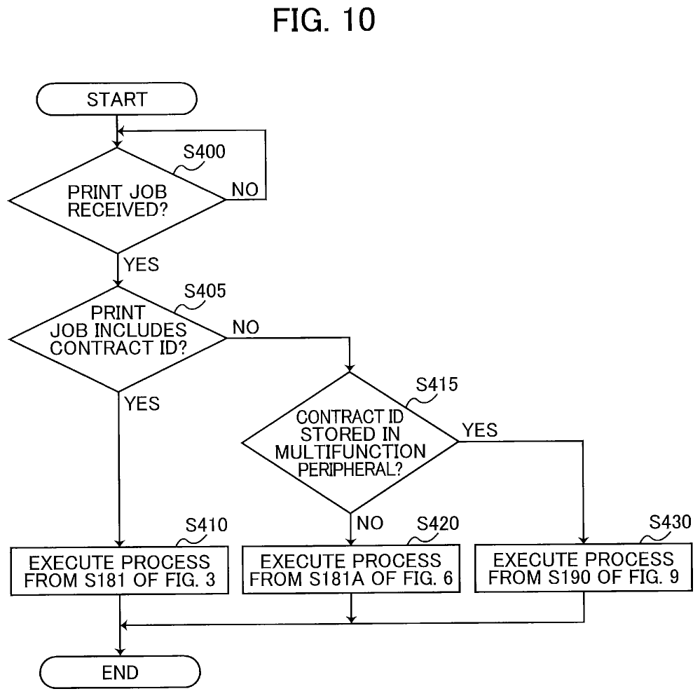

FIG. 10 is a flowchart illustrating steps in a process executed by the multifunction peripheral.

FIG. 1 illustrates a printing system 1 according to one embodiment of the present disclosure. In the present embodiment, the printing system 1 provides a printing service in which users, i.e., customers can use the printing function of a multifunction peripheral 200 by paying a fee.

<Outline of Printing System>

The printing system 1 illustrated in FIG. 1 includes a contract server 100, the multifunction peripheral 200, an information terminal 300, and a payment server 400. The contract server 100, the multifunction peripheral 200, the information terminal 300, and the payment server 400 are interconnected over a network NT to communicate with each other. The information terminal 300 is an example of the external device, and the contract server 100 is an example of the contract processing server.

<Contract Server>

The contract server 100 is installed and managed by the manufacturer of the multifunction peripheral 200, for example. The contract server 100 is configured to execute the processing regarding a contract (described later). The contract server 100 includes a processor 110, a storage device 115, and an interface 190. The processor 110, the storage device 115, and the interface 190 are interconnected via a bus 105.

The storage device 115 includes a volatile storage device 120, and a non-volatile storage device 130. The volatile storage device 120 is a DRAM, for example, and has a payment ID storage area 121, a machine ID storage area 122, a contract ID storage area 123, a payment amount storage area 124, and an image data storage area 125. The non-volatile storage device 130 is a hard disk drive or a solid state drive, for example. The non-volatile storage device 130 has a program storage area 131. The contents stored in these storage devices will be described later in detail.

The processor 110 is a device that performs data processing, such as a CPU. By executing a program stored in the program storage area 131, the processor 110 executes various processes, such as those illustrated in FIGS. 2, 3, 5, 6, 8, 9, and the like described later, including processes for performing data communications with the information terminal 300, the multifunction peripheral 200, and the payment server 400 connected to the network NT.

The interface 190 is a wired LAN interface or a wireless interface for communicating with other devices. The interface 190 is connected to the network NT.

<Payment Server>

The payment server 400 is installed at a company providing various online services for settling online payments, for example. Although not illustrated in the drawings, the payment server 400 includes a processor, a storage device, and an interface for connecting to the network NT.

<Multifunction Peripheral>

The multifunction peripheral 200 is owned by a company providing the printing service described above, for example. In this example, the multifunction peripheral 200 is installed in locations such as public facilities, stores, facilities for various services, and the like that are available to unspecified users, for example. The multifunction peripheral 200 includes a scanning unit 280, a printing unit 290, a processor 210, a storage device 215, a display unit 240, a user-operable operating unit 250, and a communication interface 270. The scanning unit 280, the printing unit 290, the processor 210, the storage device 215, the display unit 240, the operating unit 250, and the communication interface 270 are interconnected via a bus 205. The multifunction peripheral 200 is an example of the printer.

The storage device 215 has a volatile storage device 220, and a non-volatile storage device 230. The volatile storage device 220 is a DRAM, for example. The volatile storage device 220 includes an image data storage area 222 for storing therein image data. The non-volatile storage device 230 is a flash memory, for example. The non-volatile storage device 230 has a program storage area 232 for storing therein various programs, and a machine ID storage area 234. Of programs stored in the program storage area 232, print programs according to the present embodiment for executing the processes in FIGS. 2, 3, 5, 6, 8, 9 and the like are pre-stored as firmware, for example.

The processor 210 is a device such as a CPU that performs data processing. By executing a program stored in the program storage area 232, the processor 210 executes a print control in cooperation with the processor 110 of the contract server 100 for controlling the printing unit 290 to print images based on image data transmitted from the information terminal 300. The processor 210 is an example of the controller.

The display unit 240 is a liquid crystal display, for example. The operating unit 250 is a device that receives user operations. By operating the operating unit 250, the user can input various instructions into the multifunction peripheral 200. The communication interface 270 is a wired or wireless network interface for communicating with other devices. The communication interface 270 is connected to the network NT.

The scanning unit 280 is configured to optically read a document or other scanning target using photoelectric conversion elements such as a CCD or a CMOS, and to generate image data representing an image of the scanning target.

The printing unit 290 is configured to print images according to a prescribed method on paper picked up from a feed tray and conveyed using a conveying mechanism (not illustrated). The following specification describes a case in which the printing unit 290 performs printing according to an inkjet method. The paper is an example of a print medium.

<Information Terminal>

The information terminal 300 in the present embodiment is an information terminal such as a personal computer, a tablet computer, or a smartphone possessed by the user. The information terminal 300 is connected to the network NT through wireless communication. Although not illustrated in the drawings, the information terminal 300 includes a processor, a storage device, and an interface for connecting to the network NT. A preinstalled application program for utilizing the printing service described above is provided in the information terminal 300. The application program is executed and developed on an OS, for example. Note that other types of information terminals may be used as the information terminal 300.

### FEATURES OF THE EMBODIMENT

The features of the present embodiment are processes for restraining unauthorized printing by users other than legitimate users under contract. Hereinafter, detailed description as to the features will be made below in sequence.

<Process Flow>

The control processes executed by the processor 210 of the multifunction peripheral 200, the processor 110 of the contract server 100, the processor of the payment server 400, and the processor of the information terminal 300 will be described while referring to FIGS. 2 and 3. Note that, in the following description as to the control processes (illustrated in FIGS. 2, 3, 5, 6, 8, 9, and the like), references relating to “the processors” will be omitted. As an example, the phrases such as “the processor 210 of the multifunction peripheral 200” or “by the processor 210 of the multifunction peripheral 200” will be simply referred to as “the multifunction peripheral 200” or “by the multifunction peripheral 200”, respectively.

In S60 of FIG. 2, the user first performs appropriate operations on an operating unit of the information terminal 300 to designate a printer the user wishes to use. In this example, the multifunction peripheral 200 is designated in S60. In S70 the user specifies a print file containing image data prepared in advance and issues a print instruction. Upon receiving the print instruction, in S76 the information terminal 300 calculates a fee to be charged to the user for printing for the image data in the specified print file, and displays the fee on an appropriate display unit.

In order to calculate the fee, the information terminal 300 uses a prescribed fee table stored in an appropriate storage area of the information terminal 300, for example. When performing calculation, the information terminal 300 also takes into account contents of various print settings configured by the user of the information terminal 300 at the time the print file is specified in S70.

Note that the information terminal 300 may download the fee table from the contract server 100 to use for fee calculation or may transmit the print file and print settings to the contract server 100 to have the contract server 100 perform the fee calculation. Alternatively, the information terminal 300 may transmit just information indicative of the print settings and the number of pages to be printed to the contract server 100 without transmitting the print file such that the contract server 100 can calculate the fee based on this information.

After confirming the fee displayed on the information terminal 300, in S80 the user indicates the payment amount of the above fee to be paid and the payment method for paying the fee through suitable operations on the operating unit of the information terminal 300 to instruct to start payment of the fee. In S82 the information terminal 300 transmits a payment start request to the contract server 100. The payment start request includes the payment amount, the payment method, and a machine ID for identifying the printer designated in S60 (the multifunction peripheral 200 in this example).

Upon receiving the payment start request in S82, in S84 the contract server 100 transmits, to the payment server 400, a payment start command corresponding to the payment start request in order to initiate payment. The payment start command includes the payment amount received in S82, and a URL of the contract server 100 for receiving a payment completion notification described later.

Upon receiving the payment start command in S84, in S86 the payment server 400 generates a payment ID used for identifying the payment for the fee, and transmits the generated payment ID to the contract server 100. At this time, the payment server 400 also transmits a payment URL to the contract server 100 through which the information terminal 300 can issue a payment approval to the payment server 400, as will be described later.

In response to receiving the payment ID, in S90 the contract server 100 generates a contract ID used to identify a new printing service contract that will be established through the payment. The process in S90 is an example of the (2c) generating. The new printing service contract is an example of the printing service contract, and the contract ID generated in S90 is an example of the contract information.

Subsequently, in S95 the contract server 100 associates the contract ID generated in S90 with the payment ID. Specifically, in S95 the contract server 100 stores the contract ID, the payment ID received in S88, the payment amount received in S82, and the machine ID received in S82 in the corresponding contract ID storage area 123, payment ID storage area 121, payment amount storage area 124, and machine ID storage area 122 while these IDs are associated with one another. The process in S95 is an example of the (2d) associating.

In S97 the contract server 100 transmits the payment ID and the payment URL received in S88, and the contract ID generated in S90 to the information terminal 300. The process in S97 is an example of the (2e) transmitting, and the information terminal 300 as the transmission destination in S97 is an example of the second external device.

Upon receiving the payment URL and the contract ID, in S100 the information terminal 300 starts up a payment application provided in advance and displays a prescribed payment confirmation screen that includes the payment ID. In S101 the user confirms contents of the displayed payment confirmation screen, accesses the payment URL, and performs appropriate operations on a screen subsequently displayed on the information terminal 300 in order to approve the payment. As a result, in S105 the information terminal 300 transmits a payment approval notification including the payment ID to the payment server 400 indicating that the payment has been approved, i.e., that payment of the fee described above has been approved.

Upon receiving the payment approval notification, in S110 the payment server 400 transmits a payment completion notification that includes the payment ID described above to the contract server 100. Here, the payment server 400 transmits the payment completion notification through the URL received from the contract server 100 in S84 for this purpose. In response to receiving the payment completion notification, in S115 the contract server 100 registers information indicating that the fee has been paid for the contract ID associated with the payment ID.

In the meantime, after completing the process in S105 described above, in S120 the information terminal 300 transmits the contract ID received in S97 to the contract server 100, i.e., transmits an inquiry inquiring whether or not the fee associated with the contract ID has been paid. Upon receiving the inquiry, in S125 the contract server 100 performs a search for the received contract ID, and in S130 transmits the result of the search to the information terminal 300 in response to the inquiry. When the result of the search shows that the information indicating that the fee has been paid is registered in S115, in S130 the contract server 100 transmits a response to the information terminal 300 indicating that the fee associated with the contract ID has been paid and the information terminal 300 receives the response in S130.

Continuing in FIG. 3, the information terminal 300 generates a print job that includes the image data described above, and in S180 transmits the generated print job to the multifunction peripheral 200. At this time, the print job is transmitted in a form that includes the print settings described above, and the contract ID received in S97.

The multifunction peripheral 200 receives the print job from the information terminal 300 in S180. Accordingly, in S180 the multifunction peripheral 200 acquires the print settings and the contract ID included in the print job. Further, the contract ID received in S180 is an example of the authority information to print the image.

Next, in S181 the multifunction peripheral 200 confirms contents of the print job in S180 and determines whether a contract ID is included in the print job. The process in S181 is an example of the (1a) determining and the (a) determining.

When confirming the contents of the print job and determining in S181 that a contract ID is included in the print job, in S182 the multifunction peripheral 200 transmits the contract ID received in S180 to the contract server 100, that is, transmits an inquiry whether information indicating that the fee has been paid for the contract ID is registered, as described above. That is, the multifunction peripheral 200 transmits an inquiry whether the contract ID received in S180 coincides with a valid contract ID based on a valid contract at this point in time, i.e., a contract ID that the contract server 100 transmitted in S97 described above. The process in S182 is an example of the (1b) transmitting, the (b) transmitting, and the (b) making.

Upon receiving the above inquiry transmitted in S182, in S184 the contract server 100 performs search for the contract ID to determine whether the contract ID received from the multifunction peripheral 200 is among the contract IDs registered in S115 described above. In S186 the contract server 100 transmits the result of the search to the multifunction peripheral 200 as a response, and the multifunction peripheral 200 acquires the result in S186. The process of S186 is an example of the (2a) transmitting and the (c) making.

In S189 the multifunction peripheral 200 determines the validity of the contract ID subject to the inquiry in S182 based on contents of the result acquired from the contract server 100. The multifunction peripheral 200 determines that the contract ID is valid when the acquired result indicates that the contract ID is among the contract IDs registered on the contract server 100 in S115. On the other hand, the multifunction peripheral 200 determines that the contract ID is invalid when the contract ID is not among the registered IDs in S115, after which the process is ended. In other words, determining the validity of the contract ID is equivalent to determining whether the print job received in S180 is associated with a valid contract ID under the printing service contract described above whose fee has been paid. The process of S189 is an example of the (1c) determining, (c) determining, and the (d) determining. The contract ID associated with the print job is an example of the prescribed contract information. The printing service contract is an example of the prescribed printing service contract.

When the multifunction peripheral 200 determines in S189 that the contract ID is valid, in S200 the multifunction peripheral 200 transmits a maximum count acquisition request to the contract server 100 in order to acquire information on the maximum print count for the multifunction peripheral 200 previously agreed upon in the printing service contract described above. The maximum count acquisition request transmitted in S200 includes the contract ID described above and the print settings received in S180. The process in S200 is an example of the (1e) transmitting. The maximum count acquisition request is an example of the request. The maximum print count is an example of the restriction information.

Upon receiving the maximum count acquisition request for a maximum print count, in S210 the contract server 100 sets an upper limit for the print count (i.e., the maximum number of pages) allowed to be printed on the multifunction peripheral 200 based on the payment amount associated in S95 with the contract ID received in S200 and the print settings received in S200. The contract server 100 transmits the set upper limit, N pages (where N is a natural number) in this example, to the multifunction peripheral 200. Thereafter, the multifunction peripheral 200 prints images in the print job within a range allowed by the upper limit, i.e., within the maximum number of pages allowed to be printed by the multifunction peripheral 200 under the contract. The process in S210 is an example of the (2b) transmitting.

After receiving the upper limit of the print count in S210, in S215 the multifunction peripheral 200 transmits a first page print notification to the contract server 100 indicating that the multifunction peripheral 200 will start a printing operation for the first page (performed in S230 described later) of the image data (i.e., print data) included in the print job received in S180. After receiving the first page print notification, in S220 the contract server 100 decreases the balance of an account or the like designated in advance as the debit destination for fees corresponding to the printing service contract described above by an amount corresponding to the first page of the print job. In S225 the contract server 100 then transmits a print permitting notification to the multifunction peripheral 200 indicating that the printing operation for the first page is permitted.

In response to receiving the print permitting notification for the first page, in S230 the multifunction peripheral 200 forms images represented by the print data for the first page on paper. After performing the process of S230, in S235 the multifunction peripheral 200 transmits a second page print notification to the contract server 100 indicating that the multifunction peripheral 200 will start a printing operation for the second page. Based on the received second page print notification, in S240 the contract server 100 decreases the account balance by an amount for printing the second page, in the way the same as the first page, and in S245 transmits a print permitting notification to the multifunction peripheral 200 indicating that the printing operation for the second page is permitted. After receiving the print permitting notification for the second page, in S250 the multifunction peripheral 200 forms images represented by the print data for the second page on paper.

Thereafter, the above process is repeated for performing printing operation for each page on the multifunction peripheral 200. Specifically, the multifunction peripheral 200 transmits a print notification to the contract server 100 prior to performing printing operation for each page and the contract server 100 returning a print permitting notification after decreasing the account balance for the corresponding page.

While performing printing operations, the multifunction peripheral 200 performs determination in S270 to determine whether printing operations for all pages in the print job received in S180 have been completed. When the multifunction peripheral 200 determines in S270 that the printing operations for all pages have not yet been completed (S270: NO), the multifunction peripheral 200 continues to perform printing for the next page. When the multifunction peripheral 200 determines that the printing operations for all pages have been completed (S270: YES), in S279 the multifunction peripheral 200 transmits a print completion notification to the information terminal 300. The information terminal 300 receives in S279 the print completion notification, and the sequence flow in FIG. 3 is ended. The processes in S230, S250, S270 and the like are examples of the (1d) printing, the (d) printing, and the (e) printing.

### ADVANTAGES OF THE EMBODIMENT

With the printing system 1 according to the embodiment described above, the information terminal 300 transmits a print job to the multifunction peripheral 200 (S180). In S181 the multifunction peripheral 200 confirms to determine whether the print job includes a contract ID for performing printing for the print job. In S182 the multifunction peripheral 200 transmits an inquiry to the contract server 100 to determine the validity of the contract ID, and in S186 the contract server 100 responds to the inquiry. In response to the multifunction peripheral 200 determining in S189 that the contract ID is valid based on the response received from the contract server 100 in S186, then the multifunction peripheral 200 forms images on paper that correspond to the print data in the print job (S230, S250, etc.).

In this way, the multifunction peripheral 200 in the present embodiment determines whether the multifunction peripheral 200 has printing authority for the print job received from the information terminal 300 (S181). When the multifunction peripheral 200 has printing authority, the multifunction peripheral 200 determines whether this printing authority is valid through an inquiry to the contract server 100 (S189). When the multifunction peripheral 200 acquires confirmation of this validity, the multifunction peripheral 200 performs printing for the print job. In other words, the multifunction peripheral 200 does not perform printing operation when the multifunction peripheral 200 is not recognized as having printing authority to perform printing for the print job.

The above process can restrain the unauthorized printing of print jobs on the multifunction peripheral 200. Unauthorized printing includes cases in which the print job is transmitted by a person other than the user who previously concluded a contract to execute the print job on the multifunction peripheral 200 or cases in which the multifunction peripheral 200 differs from the multifunction peripheral for which the contract to execute this print job has been concluded. Accordingly, user confidence for using the printing service can be improved, and the service provider can be restrained from incurring loss due to unauthorized use and the like.

One feature of the present embodiment is that the multifunction peripheral 200 transmits in S200 a request to the contract server 100 when executing a print job to request restriction information indicating a restriction imposed on the printing process (the process in S230, S250, S270 and the like). In the above example, the multifunction peripheral 200 requests information on the maximum print count (the maximum count acquisition request) as the restriction information. In response to receiving the request, in S210 the contract server 100 transmits the restriction information to the multifunction peripheral 200. In this example, the contract server 100 transmits the upper limit of the print count. Thus, the multifunction peripheral 200 forms images on paper within a range not exceeding the limit provided by the restriction information. Consequently, when any restrictions have been added to the printing authority granted to the multifunction peripheral 200, as described above, the multifunction peripheral 200 can execute print jobs only within the limits of those restrictions.

Another feature of the present embodiment is that an upper limit of the print count is set in the restriction information transmitted from the contract server 100 to the multifunction peripheral 200, and the multifunction peripheral 200 forms images so that the print count does not exceed the set upper limit. Thus, when an upper limit of the print count is preset within the printing authority, the multifunction peripheral 200 can only execute print jobs whose print count does not exceed the upper limit.

Another feature of the present embodiment is that the print job received from the information terminal 300 includes a contract ID. The multifunction peripheral 200 transmits an inquiry to the contract server 100 in S182 to determine the validity of the contract ID. Based on the response to the inquiry obtained from the contract server 100 in S186, the multifunction peripheral 200 can clearly determine that the source of the print job is the information terminal 300 whose user has legitimate authority to for perform printing on the multifunction peripheral 200, when determining in S189 that the contract ID in the print job is valid.

Another feature of the present embodiment is that the contract server 100 concludes a contract for a printing service with the user in advance in order to provide the printing service to the user. The user is guaranteed legitimate authority to execute printing for the print job described above through the contract ID generated for this printing service contract. That is, the contract server 100 in the printing system 1 according to the present embodiment generates a contract ID in S90 described above based on the printing service contract and in S95 associates the generated contract ID with the payment of the fee for executing the print job. In S97 the contract server 100 transmits the contract ID associated with the payment of the fee to the information terminal 300 involved in the above printing service contract.

As a result of this process, in the subsequent process of S182, the multifunction peripheral 200 can inquire of the contract server 100 whether a contract ID included in a print job received from the information terminal 300 is a contract ID that the contract server 100 transmitted to the information terminal 300 in S97, as described above. In other words, the multifunction peripheral 200 can inquire whether the received print job is a legitimate print job for which a contract has been established.

Another feature of the present embodiment is that when the multifunction peripheral 200 receives a print job in S180, in S189 the multifunction peripheral 200 determines whether the print job is associated with a contract ID registered on the contract server 100 for this printing service contract. This process enables the multifunction peripheral 200 to determine that the information terminal 300 from which the print job is transmitted has legitimate authority to print on the multifunction peripheral 200, when a registered contract ID is associated with the print job.

<Variations and Modifications>

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. Note that, in the modifications described below, parts and components the same as the embodiment described above are designated with the same reference numerals appropriately to avoid the duplicating description.

<(1) Modification where Print Job does not Include Contract ID>

Next, modification (1) will be described with reference to FIGS. 4 to 6. In modification (1), the multifunction peripheral 200 is owned by a specific user who utilizes the printing service described above, for example. That is, the multifunction peripheral 200 is installed in a residence, a warehouse, an office, or the like owned by the user, for example.

FIG. 4, which corresponds to FIG. 1 in the embodiment described above, illustrates the outlined configuration of a printing system 1 according to the present modification. As illustrated in FIG. 4, the printing system of the present modification differs from the embodiment in the configuration of a storage device 215 provided in a multifunction peripheral 200. Specifically, a volatile storage device 220 of the storage device 215 has a contract ID storage area 224 in addition to the image data storage area 222. The remaining configuration of the printing system 1 is identical to that in FIG. 1 of the embodiment.

FIGS. 5 and 6 in the present modification, which respectively correspond to FIGS. 2 and 3 in the embodiment, illustrate the main portion of processes executed by the processor 210 of the multifunction peripheral 200, the processor 110 of the contract server 100, the processor of the payment server 400, and the processor of the information terminal 300.

In S60 of FIG. 5 according to the present modification, the user first designates the printer to be used for printing, as in FIG. 2 of the embodiment. In S62 the user performs appropriate operations on the operating unit of the information terminal 300 to display a balance management page on the information terminal 300. The balance management page is displayed for managing the balance of the specific user's account or the like, which has been prepared in advance as the debit destination for fees to be paid when using the printing service. In response to receiving the user operations, in S64 the information terminal 300 transmits a balance management page acquisition request to the contract server 100 so that the information terminal 300 can acquire the balance management page. The balance management page acquisition request includes the machine ID used to identify the printer that has been designated in S60 described above, that is, the multifunction peripheral 200 in this example. The information terminal 300 serving as the source of the transmission of the machine ID in S64 is an example of the second external device. The machine ID included in the balance management page acquisition request is an example of the second printer identification information. The multifunction peripheral 200 possessing the machine ID is an example of the second printer associated with the second external device.

Upon receiving the balance management page acquisition request in S64, the contract server 100 outputs display data by return to the information terminal 300 in an appropriate file format for displaying the corresponding balance management page. The information terminal 300 acquires the display data, and in S66 displays the prescribed balance management page. After confirming the balance in the balance management page displayed on the information terminal 300, in S80 the user performs suitable operations on the operating unit of the information terminal 300, as in the embodiment described above, indicative of the amount of the above fee to be paid and the payment method for paying the fee in order to instruct start of payment. Thereafter, the same steps S82 to S130 illustrated in FIG. 2 of the embodiment are executed.

That is, the payment server 400 generates a payment ID in response to receiving the payment start command from the contract server 100 commanding the payment server 400 to start payment (S86), and the contract server 100 generates a contract ID for the new printing service contract and stores the contract ID in association with the machine ID, the payment amount received from the information terminal 300, and the payment ID (S90, S95). The process in S90 is an example of the (2g) generating, and the process in S95 is an example of the (2h) associating.

The contract server 100 transmits the payment ID, the payment URL, and the contract ID to the information terminal 300. The information terminal 300 displays the payment confirmation screen and, after receiving confirmation from the user, transmits a payment approval notification to the payment server 400. The payment server 400 transmits a payment completion notification to the contract server 100 and, in response, the contract server 100 registers information indicating that the fee has been paid for the contract ID associated with the payment ID. Thus, in response to a subsequent inquiry from the information terminal 300, the contract server 100 returns a response indicating that the fee has been paid (S130).

Next, in S170 of FIG. 6 according to the present modification, the user designates a printer to be used for printing (the multifunction peripheral 200 in this example), as in the process of S60 described above. In S175, as in S70 of FIG. 2 described in the embodiment, the user specifies a print file containing prepared image data and issues a print instruction through suitable operations on the operating unit of the information terminal 300. When specifying the print file, the user also sets values for various print settings.

In S180A, which corresponds to S180 in FIG. 2, the information terminal 300 generates a print job that includes the image data described above and transmits the generated print job to the multifunction peripheral 200. At this time, the print job is transmitted in a form that includes the print settings. When receiving the print job from the information terminal 300, the multifunction peripheral 200 acquires the print settings included in the print job.

In S181A, which corresponds to S181 in FIG. 3, the multifunction peripheral 200 determines (confirms) whether the multifunction peripheral 200 possesses a machine ID. The machine ID is an example of the authority information. The process in S181 is also an example of the (a1) determining and the (a) determining.

When determining in S181A that a machine ID is provided in the multifunction peripheral 200, in S183 the multifunction peripheral 200 transmits a contract ID acquisition request to the contract server 100 in order to acquire a contract ID. The machine ID of the multifunction peripheral 200 is included in the contract ID acquisition request. The machine ID included in the contract ID acquisition request is an example of the printer identification information.

By transmitting the contract ID acquisition request, the multifunction peripheral 200 transmits an inquiry to the contract server 100 inquiring whether any contract ID associated with the machine ID in S95 described above is included in the contract IDs registered as having paid in S115 described above. From another perspective, this inquiry is equivalent to inquiring whether the machine ID has already been associated with a contract ID registered as paid in S115 described above. In other words, this inquiry is inquiring whether the machine ID is associated with a valid contract ID indicating that a legitimate authority is granted in advance on the basis of the contract described above, and thus the multifunction peripheral 200 possessing the machine ID has legitimate authority to execute the print job. The process in S183 is also an example of the (1b) transmitting, the (b) transmitting, and the (b) making.

Upon receiving the contract ID acquisition request, in S185 the contract server 100 performs search to determine whether any contract ID associated with the machine ID received from the multifunction peripheral 200 is included in contract IDs registered in S115 described above. In S187 the contract server 100 transmits the result of the search to the multifunction peripheral 200 as a response. In other words, when the contract server 100 finds (determines that) a contract ID associated with the machine ID received from the multifunction peripheral 200, the contract server 100 transmits the contract ID to the multifunction peripheral 200 as a response. The multifunction peripheral 200 acquires the contract ID from the contract server 100 and stores the contract ID in the contract ID storage area 224. The process in S185 is an example of the (2f) determining. The process in S187 is also an example of the (2a) transmitting and the (c) making.

After receiving the contract ID, in S189A, which corresponds to S189 in FIG. 3 of the embodiment, the multifunction peripheral 200 determines the validity of the execution authority for the machine ID based on contents of the result of the search. That is, when the contract server 100 finds a contract ID in S185 that corresponds to the machine ID received in S183, the multifunction peripheral 200, after acquiring the contract ID in S187, determines that a valid contract ID has been obtained and, hence, that the execution authority for the machine ID is valid. On the other hand, when the contract server 100 did not find a contract ID in S185 associated with the machine ID received in S183, the multifunction peripheral 200 does not receive a contract ID in S187. Accordingly, the multifunction peripheral 200 determines that a valid contract ID does not exist and, hence, that the execution authority for the machine ID is invalid, and the process in FIG. 6 is ended.

In other words, determining the validity of the execution authority for this machine ID is equivalent to determining whether the print job received in S180A described above has been associated with a valid contract ID for which fee has been paid under the printing service contract described above. The process in S189A is also an example of the (1c) determining, (c) determining, and the (d) determining.

The process in S200 to S279 following the process of S189A are the same as those in FIG. 3 of the embodiment, and the description will not be repeated.

<Advantages of Modification (1)>

The modification (1) obtains the same advantages as the embodiment described above. Specifically, after the multifunction peripheral 200 receives a print job from the information terminal 300 in S180A, in S181A the multifunction peripheral 200 determines the existence of a machine ID for executing the received print job. In S183 the multifunction peripheral 200 transmits an inquiry to the contract server 100 for determining whether the execution authority of the machine ID determined in S181A is valid, and the contract server 100 responds to the inquiry in S187. The multifunction peripheral 200 forms images corresponding to print data in the print job on paper (S230, S250, etc.) when the multifunction peripheral 200 determines in S189A that the execution authority for the machine ID is valid based on the response from the contract server 100.

In the present modification described above, as in the embodiment, the multifunction peripheral 200 determines whether the multifunction peripheral 200 itself has printing authority to perform printing operation for the print job received from the information terminal 300 (S181A), and transmits an inquiry to the contract server 100 in order to determine whether the printing authority is valid (S189A). The multifunction peripheral 200 executes printing operation for the print job when obtaining confirmation that the printing authority is valid. In other words, printing operation is not performed when the multifunction peripheral 200 is not recognized as having printing authority to printing operation for the print job. As in the embodiment described above, this process can restrain the unauthorized printing of print jobs on the multifunction peripheral 200. As a result, this modification can also improve user confidence while restraining the service provider from incurring loss.

In particular, the present modification can associate a plurality of contract IDs with a single multifunction peripheral 200 (i.e., the machine ID). In this case, when one of the contact IDs is used up (e.g., when the upper limit of the print count has been met), the multifunction peripheral 200 can automatically switch to another of the contract IDs.

Another feature of the present modification is that a contract for the printing service is concluded with the user in advance in order for the user to execute a print job on the multifunction peripheral 200. A contract ID based on this printing service contract guarantees the user legitimate authority to execute a print job. Specifically, in S183 of the present modification, the multifunction peripheral 200 inquires of the contract server 100 as to whether there is a valid contract ID guaranteeing the execution of a print job. When the result provided in a response from the contract server 100 indicates that a valid contract ID exists for the multifunction peripheral 200, the multifunction peripheral 200 can clearly determine, based on the contract ID, that the multifunction peripheral 200 has legitimate authority to perform printing operation for the print job.

Another feature of the present modification is that the machine ID of the multifunction peripheral 200 is associated with the contract ID acquisition request that the multifunction peripheral 200 transmits in the inquiry in S183. In response to the contract ID request, the contract server 100 executes a search for a contract ID in S185 and determines whether there is a registered contract ID previously associated with the machine ID. When the contract server 100 finds a contract ID previously associated with the machine ID, i.e., when the contract server 100 finds a contract ID for which valid printing authority has been previously granted to the multifunction peripheral 200, the contract server 100 transmits the contract ID to the multifunction peripheral 200 in a response. This process enables the multifunction peripheral 200 to determine reliably whether the multifunction peripheral 200 has legitimate authority to execute printing operation for the print job based on the unique machine ID of the multifunction peripheral 200.

Although contract ID(s) is associated with each machine ID in the above example, contract IDs may be associated with each user ID instead. In this case, the multifunction peripheral 200 may acquire the user ID from the information terminal 300 in S180A, and may transmit the user ID together with the machine ID to the contract server 100 in S183. The user ID in this case is another example of the authority information.

Another feature of the present modification is that the contract for a printing service is concluded with the user in advance, as described above. To this end, the information terminal 300 used for establishing the printing service contract transmits the machine ID of the multifunction peripheral 200 associated with the information terminal 300 to the contract server 100 in S64. At this time, the contract server 100 generates a corresponding contract ID (S90), and associates the generated contract ID with a payment for executing a print job and the received machine ID received (S95). Thus, in S183 the multifunction peripheral 200 can ensure to inquire of the contract server 100 as to whether the machine ID of the multifunction peripheral 200 has been associated with the contract ID and the fee payment to determine reliably whether the multifunction peripheral 200 has legitimate printing authority to execute a print job for which payment has been settled.

<(2) Modification where Contract ID is Saved in Multifunction Peripheral>

Next, modification (2) will be described while referring to FIGS. 7 to 9. As in modification (1) described above, the multifunction peripheral 200 in this modification (2) is owned by a specific user who receives the printing service described above, for example.

FIG. 7, which corresponds to FIG. 4 in modification (1) described above, illustrates the outlined configuration of a printing system 1 in the present modification. As illustrated in FIG. 7, the printing system 1 in the present modification differs from modification (1) in the configuration of a storage device 215 in a multifunction peripheral 200. Specifically, a volatile storage device 220 in the present modification has only the image data storage area 222 described above, while a non-volatile storage device 230 has a contract ID storage area 236 in addition to the program storage area 232 and the machine ID storage area 234 described above. The remaining configuration in the present modification are identical to those illustrated in FIG. 4.

The main portion of processes executed by the processor 210 of the multifunction peripheral 200, the processor 110 of the contract server 100, the processor of the payment server 400, and the processor of the information terminal 300 according to the present modification will be described with reference to FIGS. 8 and 9, which correspond to FIGS. 5 and 6 of modification (1).

As illustrated in FIG. 8, the process in S60 to S130 in the present modification are identical to those of modification (1) described in FIG. 5. Specifically, after the user performs an operation to display the balance management page on the information terminal 300 and inputs instruction to start payment, the payment server 400 generates a payment ID (S86). Thereafter, the contract server 100 stores the contract ID generated for the new printing service contract in association with the machine ID, the payment ID, and the payment amount received from the information terminal 300 (S90, S95).

The contract server 100 transmits the payment URL and the contract ID to the information terminal 300 (S97). After the user views the payment confirmation screen displayed on the information terminal 300 and indicates approval, the information terminal 300 transmits a payment approval notification to the payment server 400. Upon receiving a payment completion notification from the payment server 400, the contract server 100 registers information indicating that the fee has been paid for the contract ID associated with the payment ID (S115). After receiving a subsequent inquiry from the information terminal 300 regarding the same contract ID, the contract server 100 transmits a response indicating that the fee has been paid (S130).

Subsequently, in S140 of the present modification, the user confirms the existence of a contract ID received and displayed on the information terminal 300 in S100 and performs an operation on the information terminal 300 so that the contract ID is saved in the multifunction peripheral 200. Here, the user also inputs an administrator password determined in advance when performing the operation in S140. This password is necessary for preventing a person other than the user from maliciously performing an operation to save a contract ID, i.e., a person impersonating the user.

In response to the user operation, in S145 the information terminal 300 transmits a contract ID save command to the multifunction peripheral 200 that commands the multifunction peripheral 200 to save the contract ID thereon, and the multifunction peripheral 200 receives the contract ID save command. The contract ID save command includes the contract ID and the administrator password described above. The contract ID acquired by the multifunction peripheral 200 in S145 is another example of the authority information.

Upon receiving the contract ID save command, in S181B which corresponds to S181A in FIG. 6, the multifunction peripheral 200 determines (confirms) whether the multifunction peripheral 200 currently possesses a contract ID. At this time, the contract ID included in the contract ID save command is temporarily saved in a prescribed address in the multifunction peripheral 200 before the contract ID is saved in the contract ID storage area 236. The process in S118B is also an example of the (a1) determining and the (a) determining.

In S150 the multifunction peripheral 200 transmits the contract ID received from the information terminal 300 to the contract server 100 and inquires whether the contract ID has been registered in S115 as a contract ID for which the fee has been paid. In other words, in S150 the multifunction peripheral 200 transmits an inquiry for determining whether the same contract ID as the transmitted contract ID is present among contract IDs that have been registered in S115 as being contractually valid, i.e., whether the multifunction peripheral 200 has legitimate authority to execute printing operation to perform the print job described below. The process in S150 is also an example of the (1b) transmitting, the (b) transmitting, and the (b) making.

The contract server 100 receives the contract ID transmitted from the multifunction peripheral 200 in S150, as described above. Upon receiving the contract ID, in S155 the contract server 100 searches for the contract ID among the contract IDs registered in S115 to determine whether the same contract ID received from the multifunction peripheral 200 has been registered, i.e., whether the received contract ID is a contract ID whose fee has been paid, as described above.

In S160 the contract server 100 transmits the result of the search to the multifunction peripheral 200 as a response. In other words, the contract server 100 transmits a response to the multifunction peripheral 200 indicating that the fee has been paid for this contract ID when the contract server 100 found a contract ID the same as the received contract ID in the registered contract IDs. The multifunction peripheral 200 then acquires the response from the contract server 100 in S160. The process in S160 executed by the contract server 100 is also an example of the (2a) transmitting and the (c) making.

Upon receiving the response, in S189B, which corresponds to S189A in FIG. 6, the multifunction peripheral 200 determines the validity of the contract ID based on contents of the result of the search. In other words, the multifunction peripheral 200 determines that a valid contract ID has been obtained when the response from the contract server 100 indicates that the contract ID transmitted in S150 is found in S155 to be a contract ID for which the fee has been paid. Conversely, the multifunction peripheral 200 determines that a valid contract ID has not been obtained when the response received from the contract server 100 does not indicate that the fee has been paid for the contract ID transmitted in S150, and the process in FIG. 8 is ended. In other words, determining the validity of the contract ID is equivalent to determining whether the print job received in S180A described later is associated with a valid contract ID whose fee has been paid for the printing service contract described above. The process of S189B is also an example of the (1c) determining, (c) determining, and the (d) determining.

In S165 the multifunction peripheral 200 saves the contract ID received in S145 in the contract ID storage area 236 and subsequently in S167 transmits a corresponding contract ID saved notification to the information terminal 300.

Continuing in FIG. 9, the process in S170 to S180A is executed as described above in FIG. 5 of modification (1). That is, in S180A the information terminal 300 transmits a print job to the multifunction peripheral 200 in response to an instruction from the user, and the multifunction peripheral 200 receives the print job.

Based on the print job received from the information terminal 300, in S190 the multifunction peripheral 200 reads the contract ID saved in the contract ID storage area 236 in S165. Thereafter, the processes in S200 to S279 the same as those in modification (1) is executed.

<Advantages of Modification (2)>

The present modification obtains the same advantages as in the embodiment described above. That is, before the multifunction peripheral 200 receives a print job from the information terminal 300 in 5180A, in S181B the multifunction peripheral 200 confirms the existence of a contract ID for executing printing operation for the print job. In S150 the multifunction peripheral 200 transmits an inquiry to the contract server 100 for determining the validity of the confirmed contract ID, and in S160 the contract server 100 responds to the inquiry. The multifunction peripheral 200 then forms images on paper that correspond to print data in the print job (S230, S250, etc.), on condition that the multifunction peripheral 200 determines in S189B based on the response received from the contract server 100 that the contract ID is valid.

As in the embodiment described above, in S181B of the present modification, the multifunction peripheral 200 determines whether the multifunction peripheral 200 has authority to perform printing operation for a print job to be received from the information terminal 300 and, by inquiring of the contract server 100, in S189B determines whether the printing authority is valid. The multifunction peripheral 200 executes printing operation for the print job when obtaining confirmation of the validity. In other words, when the multifunction peripheral 200 is not recognized as having authority to perform printing operation for the print job, the multifunction peripheral 200 does not perform printing operation. As in the embodiment described above, the above operation can restrain the multifunction peripheral 200 from performing an unauthorized printing based on the print job, thereby improving user confidence and suppressing the service provider from incurring loss.

Another feature of the present modification is that a printing service contract is concluded with the user in advance in order to execute a print job on the multifunction peripheral 200. A contract ID based on the printing service contract guarantees the user legitimate authority to execute the print job. That is, in S150 of the present modification, the multifunction peripheral 200 inquires whether authority for the multifunction peripheral 200 is guaranteed to execute the print job by a valid contract ID. When the result received in a response from the contract server 100 indicate the existence of a valid contract ID for the multifunction peripheral 200, the multifunction peripheral 200 can clearly determine that the multifunction peripheral 200 has legitimate authority to execute the print job based on this contract ID.

<(3) Modification where Operation Mode is Switched Among Three Process Modes>

In modification (3), the multifunction peripheral 200 is configured to select one of three processes: a process according to the embodiment described above in FIGS. 2 and 3; a process according to modification (1) described above in FIGS. 5 and 6; and a process according to modification (2) described above in FIGS. 8 and 9, and to perform the selected process. Specifically, when the multifunction peripheral 200 receives a print job from the information terminal 300, the multifunction peripheral 200 switches operation mode according to whether the print job includes a contract ID and the like to perform one of the above three processes.

A control process for switching operation mode to perform one of these processes will be described with reference to the flowchart in FIG. 10. The control process according to the present modification is executed by the processor 210 of the multifunction peripheral 200.

In S400 of FIG. 10, the processor 210 determines whether a print job has been received. When the processor 210 determines in S240 that a print job has not yet been received (S400: NO), the processor 210 repeats the process in S240. When it is determined in S400 that a print job has been received (S400: YES), in S405 the processor 210 determines whether the print job received from the information terminal 300 includes a contract ID.

When determining in S405 that the print job includes a contract ID (S405: YES), then the process corresponds to that described in the embodiment is subsequently performed. Accordingly, the processor 210 advances to S410 and executes the process from S181 in FIG. 3 in cooperation with the information terminal 300 and the contract server 100, and then ends the process.

On the other hand, when the processor 210 determines in S405 that the print job does not include a contract ID (S405: NO), in S415 the processor 210 determines whether a contract ID is stored in the multifunction peripheral 200.

When a contract ID is not stored on the multifunction peripheral 200 (S415: NO), then the process corresponds to that described in modification (1) is subsequently performed. Accordingly, the processor 210 advances to S420 and executes the process from S181A in FIG. 6 in cooperation with the information terminal 300 and the contract server 100, after which the process ends.

On the other hand, when a contract ID is stored on the multifunction peripheral 200 (S415: YES), then subsequent process corresponds to that described in modification (2). Accordingly, the processor 210 advances to S430 and executes the process from S190 in FIG. 9 in cooperation with the information terminal 300 and the contract server 100, and end the process.

<Advantages of Modification (3)>

Depending on which of the three processes is executed, the present modification can obtain the same advantages described in the embodiment, modification (1), or modification (2) described above.

<(4) Other Modifications>

In the above-described embodiment and modifications, fees for the printing operations are determined by way of calculation, but the other method for determining fees may be employed. For example, the fee table described above may include ranges for various parameters such as numbers of pages in the print job and coverages and may individually associate a fee amount with each of the ranges. In this case, the fee may be determined without any particular calculation by referring to the fee table.

Using the number of pages to be printed as an example, the table may record XX yen for a range of pages from A pages to B pages, XX yen for a range of pages from B pages to C pages, etc. Thus, once the number of pages in the print job is acquired, the fee can be determined directly by referencing the table without performing the calculation in the above description.

Although the multifunction peripheral 200 executes printing operation according to the inkjet method in the above description, methods other than the inkjet method may be employed. For example, the multifunction peripheral 200 may employ a laser method for performing printing operation, and the advantages the same in those in the above description can be obtained. Alternatively, the present disclosure may be applied to a printer employing the method different from the inkjet method or the laser method, such as a thermal-transfer method or the other well-known method.

The sequence diagrams illustrated in FIGS. 2, 3, 5, 6, 8, and 9 in the above description do not limit the present disclosure to the steps indicated therein. Steps may be added or deleted, or the order thereof may be changed where appropriate.

The technique described in the embodiment and modifications described above may be suitably combined to be implemented.

What is claimed is:

1. A printing system comprising:
a printer comprising a controller; and
a contract processing server,
the controller being configured to perform:
(1a) determining, in response to receiving from an external device a print job including print data representing an image, whether authority information indicating an authority to print the image has been issued; and
(1b) transmitting, in response to the (1a) determining that the authority information has been issued, to the contract processing server an inquiry for determining whether the authority information is valid,
the contract processing server being configured to perform:
(2a) transmitting, in response to receiving the inquiry transmitted in the (1b) transmitting, a response to the controller,
the controller being configured to further perform:
(1c) determining, in response to receiving the response transmitted in the (2a) transmitting, whether the authority information is valid on the basis of the received response; and
(1d) printing, in response to the (1c) determining that the authority information is valid, the image on a print medium by controlling the printer.

2. The printing system according to claim 1,
wherein the controller is configured to further perform:
(1e) transmitting a request to the contract processing server, the request requesting the contract processing server to transmit restriction information, the restriction information indicating a restriction imposed on the (1d) printing,
wherein the contract processing server is configured to further perform:
(2b) transmitting, in response to receiving the request transmitted in the (1e) transmitting, the restriction information, and
wherein the controller performs the (1d) printing within the restriction indicated by the restriction information.

3. The printing system according to claim 2,
wherein the restriction indicated by the restriction information restricts the maximum number of pages allowed to be printed in the (1d) printing, and
wherein, the controller performs the (1d) printing within the maximum number of pages restricted by the restriction indicated by the restriction information.

4. The printing system according to claim 1,
wherein the print job received from the external device further includes the authority information.

5. The printing system according to claim 4,
wherein the contract processing server is configured to further perform:
(2c) generating, in response to receiving from a second external device payment information indicative of a fee to be paid for performing the (1d) printing, contract information on the basis of a printing service contract for performing the (1d) printing;
(2d) associating the contract information generated in the (2c) generating with the payment information; and
(2e) transmitting to the second external device the contract information associated with the payment information in the (2d) associating, and
wherein the inquiry transmitted in the (1b) transmitting is an inquiry for determining whether the authority information included in the received print job coincides with the contract information transmitted to the second external device in the (2e) transmitting.

6. The printing system according to claim 1,
wherein, in the (1a) determining, the controller determines whether the authority information is present in the printer, and
wherein the inquiry transmitted in the (1b) transmitting is an inquiry whether contract information corresponding to the authority information is present, the contract information indicating that a legitimate authority is granted in advance to perform the (1d) printing on the basis of a printing service contract under which a service for performing the (1d) printing is provided.

7. The printing system according to claim 6,
wherein, the inquiry transmitted in the (1b) transmitting includes a printer identification information used to identify the printer,
wherein the contract processing server is configured to further perform:
(2f) determining, in response to receiving the inquiry transmitted in the (1b) transmitting, whether the contract information associated with the printer identification information is present, and
wherein, in response to the (2f) determining that the contract information associated with the printer identification information is present, the contract processing server transmits the contract information as the response in the (2a) transmitting.

8. The printing system according to claim 7,
wherein the contract processing server is configured to further perform:
(2g) generating, in response to receiving from a second external device payment information indicative of a fee to be paid for performing the (1d) printing, the contract information on the basis of a printing service contract for performing the (1d) printing; and
(2h) associating the contract information generated in the (2g) generating with both the payment information and second printer identification information, the second printer identification information being used to identify a second printer associated with the second external device, the second printer identification information being transmitted from the second external device, and
wherein the inquiry transmitted in the (1b) transmitting is an inquiry whether the printer identification information coincides with the second printer identification information.

9. The printing system according to claim 4,
wherein, in the (1c) determining, the controller determines whether prescribed contract information based on a prescribed printing service contract is associated with the received print job.

10. A printer comprising:
a controller configured to perform:
(a) determining, in response to receiving from an external device a print job including print data representing an image, whether authority information indicating an authority to print the image has been issued;
(b) transmitting, in response to the (a) determining that the authority information has been issued, to a contract processing server an inquiry for determining whether the authority information is valid;
(c) determining, in response to receiving a response to the inquiry from the contract processing server, whether the authority information is valid on the basis of the received response; and
(d) printing, in response to the (c) determining that the authority information is valid, the image on a print medium by controlling the printer.

11. A non-transitory computer-readable storage medium storing a set of program instructions for a printer comprising a controller,
the set of program instructions, when executed by the controller, causing the printer to perform:
(a) determining, in response to receiving from an external device a print job including print data representing an image, whether authority information indicating an authority to print the image has been issued;
(b) transmitting, in response to the (a) determining that the authority information has been issued, to a contract processing server an inquiry for determining whether the authority information is valid;
(c) determining, in response to receiving a response to the inquiry from the contract processing server, whether the authority information is valid on the basis of the received response; and
(d) printing, in response to the (c) determining that the authority information is valid, the image on a print medium.

12. A method for a printing system, the method comprising:
(a) determining, in response to receiving from an external device a print job including print data representing an image, whether authority information indicating an authority to print the image has been issued;
(b) making, in response to the (a) determining that the authority information has been issued, an inquiry for determining whether the authority information is valid;
(c) making a response to the inquiry;
(d) determining, in response to acquiring the response to the inquiry, whether the authority information is valid on the basis of the acquired response; and
(e) printing, in response to the (d) determining that the authority information is valid, the image on a print medium.
